(19) United States
(12) Patent Application Publication
(10) Pub. No.: US 2012/0176566 A1
(43) Pub. Date: Jul. 12, 2012

(54) BACKLIGHT DEVICE AND IMAGE DISPLAY APPARATUS

(75) Inventors: Hidefumi Yoshida, Osaka-shi (JP); Tsuyoshi Kamada, Osaka-shi (JP); Tsuyoshi Maeda, Osaka-shi (JP); Satoshi Shibata, Osaka-shi (JP); Hideki Uchida, Osaka-shi (JP); Kiyoshi Minoura, Osaka-shi (JP)

(73) Assignee: SHARP KABUSHIKI KAISHA, Osaka-shi, Osaka (JP)

(21) Appl. No.: 13/392,549

(22) PCT Filed: Apr. 28, 2010
(86) PCT No.: PCT/JP2010/057593

§ 371 Date: Mar. 23, 2012

(30) Foreign Application Priority Data
Sep. 1, 2009 (JP) 2009-201579

(51) Int. Cl. G02F 1/13357; G02F 1/1335

(52) U.S. Cl. 349/65; 349/112

(57) ABSTRACT

A backlight device of the present invention includes a substrate (2), a liquid crystal layer (4), and a scattering layer (5). The substrate (2) has a surface facing the liquid crystal layer (4), on which surface two comb electrodes (3a and 3b) are provided. The comb electrode (3a) includes a plurality of comb-teeth parts (33a) meshing with a plurality of comb-teeth parts (33b) of the comb electrode (3b). Therefore, the comb electrodes (3a and 3b) can causes electric fields to be generated, in response to an applied voltage, in at least two directions each parallel to the surface of the substrate (2). Further, there is a region whose effective refractive indexes with respect to polarized light p and polarized light s become large. It is therefore possible to control emission of both the polarized light p and the polarized light s.

### TECHNICAL FIELD

The present invention relates to a backlight device to be provided in an image display apparatus.

### BACKGROUND Art

An image display apparatus employing a liquid crystal display panel serves as a flat panel display characterized in thinness, lightness or the like. Such an image display apparatus has recently been in widespread use for a liquid crystal television, a monitor, a mobile phone or the like. An electronic latent image formed on a nonluminous liquid crystal display panel is visualized by external illumination means. As the external illumination means is employed natural light, or an illumination device to be provided on a back or front side of a liquid crystal display panel. In particular, a display apparatus that requires high brightness mainly employs, as the external illumination means, an illumination device provided on a backside of a liquid crystal display panel. The illumination device is called a backlight.

A backlight is classified mainly into a side edge type backlight and a direct type backlight. The side edge type backlight is configured such that linear light sources represented by a cold cathode fluorescence tube are provided along a peripheral part of a transparent light guide plate. The side edge type backlight is in widespread use for a display apparatus such as a personal computer that requires thinness. The direct type backlight is in widespread use for a large-size liquid crystal display apparatus such as a display apparatus used for a display monitor or a television receiver. The direct type backlight is configured such that an illumination device is provided directly under a backside of a liquid crystal display panel.

The direct type backlight includes a backlight in which (i) LED chips are aligned in a matrix manner and (ii) whether or not the LED chips are boosted up is controlled for each of the LED chips. FIG. 11 is a plain view showing a configuration of a backlight 100. FIG. 12 is a cross-sectional view of the backlight 100. The backlight 100 of FIGS. 11 and 12 requires a long optical distance (not less than several centimeters) between LED chips 101 and a diffusion plate 102 (see an arrow of FIG. 12), so as to eliminate shadows of the LED chips 101. In a case where the optical distance is short, such a problem that images of the LED chips 101 appear as unevenness occurs. That is, the backlight 100 itself of FIGS. 11 and 12 becomes thick. Consequently, the backlight 100 has a defect that prevents an image display apparatus from being reduced in its thickness.

Meanwhile, a side edge type backlight of FIG. 13 is configured such that (i) light enters sides of a light guide plate 201 from side edge type light sources 202, (ii) total reflection is intentionally prevented by a configuration provided on the light guide plate 201, and then (iii) the light is emitted from the light guide plate 201. The above-configured side edge type backlight does not require such a long optical distance that is required for the direct type backlight. Therefore, a thin backlight can be produced. With the configuration of the side edge type backlight, the light guide plate 201 can have a thickness as thin as several millimeters. However, the configuration of FIG. 13 cannot partially emit light, unlike the configuration of FIGS. 11 and 12.

Patent Literature 1 discloses a configuration of a side edge type backlight for partially emitting light. The configuration of Patent Literature 1 controls emission of light on the basis of a state where a voltage is applied, and functions identically with the configuration of FIG. 13.

The configuration of Patent Literature 1 is explained with reference to FIG. 14. FIG. 14 is an explanatory view of a configuration and an operation of a display apparatus disclosed in Patent Literature 1. FIG. 14 has its left side showing a state where no voltage is applied, and its right side showing a state where a voltage is applied. As shown in FIG. 14, a display apparatus 700 includes (i) a vertical alignment type liquid crystal layer 512, (ii) electrodes 514a and 514b for applying a voltage to the liquid crystal layer 512, (iii) a light guide plate 116 provided on a front side of the liquid crystal layer 512, and (iv) a backside substrate 117, a reflection layer 717, and a fluorescence layer 718 that are provided on a backside of the liquid crystal layer 512. The reflection layer 717 has an inclined surface 717b that is at an angle with a display surface (a surface of the liquid crystal layer). The inclined surface 717b reflects, toward the front side, light transmitted by the liquid crystal layer 512.

In the liquid crystal layer 512 to which a predetermined voltage is applied, linearly polarized light is transmitted by an anchor ring layer 512a, and is refracted by an intermediate layer 512b toward a direction in which the linearly polarized light entered. The liquid crystal layer 512 to which the predetermined voltage is applied apparently subjects the linearly polarized light thus entered to total reflection. The display apparatus 700 displays white while no voltage is applied to the liquid crystal layer 512, whereas the display apparatus 700 displays black while a voltage is applied to the liquid crystal layer 512. Specifically, the display apparatus 700 is configured such that light (including polarized light p and polarized light s) emitted from a light source 630 is propagated in the light guide plate 116. Note that the light guide plate 116 has a refractive index ns determined to be substantially equal to an extraordinary index ne (=n ∥) of liquid crystal molecules that constitute the liquid crystal layer 512 (ns≈ne). The liquid crystal molecules of the liquid crystal layer 512 have a negative dielectric anisotropy (Δε<0), and a positive refractive anisotropy (ne>no).

The following description will discuss the polarized light p. The liquid crystal layer 512 has a refractive index of approximately ne with respect to the polarized light p propagated in the light guide plate 116 while no voltage is applied to the liquid crystal layer 512 (see the left side of FIG. 14). Therefore, the polarized light p is not subjected to total reflection on an interface between the light guide plate 116 having a relationship of ns≈ne and the liquid crystal layer 512, but is transmitted by the liquid crystal layer 512. The polarized light p transmitted by the liquid crystal layer 512 is reflected by the inclined surface 717b, and then emitted toward an observer side.

Meanwhile, an alignment state of the anchor ring layer 512a of the liquid crystal layer 512 does not change but merely an alignment state of the intermediate layer 512b of the liquid crystal layer 512 changes while a voltage is applied to the liquid crystal layer 512 (see the right side of FIG. 14). Therefore, even while the voltage is applied to the liquid crystal layer 512, the anchor ring layer 512a has a refractive index of approximately ne with respect to the polarized light p, and the polarized light p is not subjected to total reflection on the interface between the light guide plate 116 having the relationship of ns≈ne and the liquid crystal layer 512 but enters the liquid crystal layer 512. The refractive index of the anchor ring layer 512a with respect to the polarized light p is gradually decreased toward the intermediate layer 512b to approach no. The polarized light p is consecutively refracted in the intermediate layer 512b in which the refractive index changes, and in the vicinity of the intermediate layer 512b. Subsequently, the polarized light p is directed toward the front side. Such an action of the liquid crystal layer 512 appears to be total reflection of the polarized light p in the liquid crystal layer 512. The polarized light p that is refracted in the liquid crystal layer 512 and then directed toward the light guide plate 116 is propagated in the light guide plate 116 but is not emitted toward an observer side. Note that light for use in display enters at angles of 0° through 20° with (substantially horizontal to) the interface, and therefore an action identical to the action of the liquid crystal layer 512 is carried out even in a case where a direction in which the liquid crystal molecules are inclined is not a direction shown in FIG. 14. In this manner, the display apparatus 700 of FIG. 14 displays white by use of the polarized light p while no voltage is applied, and displays black by use of the polarized light p while a voltage is applied.

### CITATION LIST

### Patent Literature

Patent Literature 1

International Publication No. WO 2006/104159 pamphlet (Publication Date: Oct. 5, 2006)

### SUMMARY OF INVENTION

### Technical Problem

However, in a case of the display apparatus of Patent Literature 1, polarized light s is subjected to total reflection on the interface between the light guide plate 116 and the liquid crystal layer 512 regardless of whether or not a voltage is applied. This is because the anchor ring layer 512a of the liquid crystal layer 512 has a refractive index no (≠ns) with respect to the polarized light s regardless of whether or not a voltage is applied.

That is, the conventional configuration has a problem that only either polarized light p or polarized light s can be contributed to display.

### Solution to Problem

The present invention was made in view of the problem, and an object of the present invention is to provide (i) a thin backlight device capable of controlling emission of both polarized light p and polarized light s and (ii) an image display apparatus.

That is, in order to attain the object, a backlight device of the present invention is a backlight device, including a light guide plate configured to emit light merely from a partial region of the light guide plate, the light guide plate including: a substrate having a side part configured to guide light into the substrate; a liquid crystal layer, provided on a side of a surface of the substrate, that is made from a material which has (i) an optical isotropy while no voltage is applied to the liquid crystal layer and (ii) a refractive index that changes in an electric field direction in response to an applied voltage; and a plurality of electrodes for causing electric fields to be generated in the liquid crystal layer, in response to an applied voltage, in at least two different directions each parallel to the surface of the substrate.

According to the configuration, the backlight device of the present invention includes (a) the liquid crystal layer which has (i) the optical isotropy while no voltage is applied to the liquid crystal layer and (ii) the refractive index that changes in the electric field direction in response to an applied voltage, and (b) the plurality of electrodes for causing the electric fields to be generated in the liquid crystal layer in the directions each parallel to the surface of the substrate. It is therefore possible to control emission of both polarized light p and polarized light s.

The backlight device of the present invention includes the liquid crystal layer and the plurality of electrodes. This specifically allows the backlight device of the present invention to employ an optical layer that is optically uniform while no voltage is applied, and both polarized light p and polarized light s meet a total reflection condition. Hence, no light is emitted. Meanwhile, this allows the backlight device of the present invention to generate the electric fields, in response to an applied voltage, in the at least two different directions each parallel to the surface of the substrate, thereby generating an optical anisotropy in two directions in the liquid crystal layer. Therefore, in either one of the two directions, an effective refractive index of polarized light p or polarized light s is different from that of polarized light p or polarized light s obtained while no voltage is applied, and the total reflection condition is not met. Hence, light is emitted. This allows both the polarized light p and the polarized light s to contribute to display.

According to the configuration of the present invention, the backlight device of the present invention is a so-called side edge type backlight. Therefore, the backlight device of the present invention is configured to partially emit light. However, the backlight device itself does not become thick. Therefore, it is possible to reduce the thickness of a liquid crystal display apparatus even in a case where the backlight device of the present invention is provided in the liquid crystal display apparatus.

According to the configuration of the present invention, it is possible to provide a thin backlight device capable of controlling emission of both polarized light p and polarized light s.

The present invention includes an image display apparatus including (i) the above-configured backlight device and (ii) a display panel.

In order to attain the object, an image display apparatus of the present invention is an image display apparatus, including display means, said display means including: a substrate having a side part configured to guide light into the substrate; and a liquid crystal layer provided on the substrate, said display means further including: a plurality of electrodes for causing electric fields to be generated in the liquid crystal layer, in response to an applied voltage, in at least two different directions each parallel to a surface of the substrate, the liquid crystal layer being made from a material which has (i) an optical isotropy while no voltage is applied to the liquid crystal layer and (ii) a refractive index that changes in an electric field direction in response to an applied voltage.

According to the configuration, it is possible to carry out liquid crystal display while having a backlight function. This makes it possible to provide a very thin image display apparatus whose components are considerably reduced in its number.

Further, according to the configuration, the backlight device of the present invention includes (a) the liquid crystal layer which has (i) the optical isotropy while no voltage is applied to the liquid crystal layer and (ii) the refractive index that changes in the electric field direction in response to an applied voltage, and (b) the plurality of electrodes for causing the electric fields to be generated in the liquid crystal layer in the directions each parallel to the surface of the substrate. It is therefore possible to control emission of both polarized light p and polarized light s.

The backlight device of the present invention includes the liquid crystal layer and the plurality of electrodes. This specifically allows the backlight device of the present invention to employ an optical layer that is optically uniform while no voltage is applied, and both polarized light p and polarized light s meet a total reflection condition. Hence, no light is emitted. Meanwhile, this allows the backlight device of the present invention to generate the electric fields, in response to an applied voltage, in the at least two different directions each parallel to the surface of the substrate, thereby generating an optical anisotropy in two directions in the liquid crystal layer. Therefore, in either one of the two directions, an effective refractive index of polarized light p or polarized light s is different from that of polarized light p or polarized light s obtained while no voltage is applied, and the total reflection condition is not met. Hence, light is emitted. This allows both the polarized light p and the polarized light s to contribute to display.

For a fuller understanding of the nature and advantages of the invention, reference should be made to the ensuing detailed description taken in conjunction with the accompanying drawings.

### Advantageous Effects of Invention

In order to attain the object, a backlight device of the present invention is a backlight device, including a light guide plate configured to emit light merely from a partial region of the light guide plate,

the light guide plate including:
a substrate having a side part configured to guide light into the substrate;
a liquid crystal layer, provided on a side of a surface of the substrate, that is made from a material which has (i) an optical isotropy while no voltage is applied to the liquid crystal layer and (ii) a refractive index that changes in an electric field direction in response to an applied voltage; and
a plurality of electrodes for causing electric fields to be generated in the liquid crystal layer, in response to an applied voltage, in at least two different directions each parallel to the surface of the substrate.

This makes it possible to provide a thin backlight device capable of controlling emission of both polarized light p and polarized light s.

It is also possible to provide an area control type display apparatus in a case where the backlight device is provided in a display apparatus as external illumination means of the display apparatus.

The present invention functions also as a liquid crystal display apparatus for carrying out liquid crystal display by employing the configuration of the backlight device.

That is, the present invention includes an image display apparatus, including display means,

said display means including: a substrate having a side part configured to guide light into the substrate; and a liquid crystal layer provided on the substrate,

said display means further including:

a plurality of electrodes for causing electric fields to be generated in the liquid crystal layer, in response to an applied voltage, in at least two different directions each parallel to a surface of the substrate,

the liquid crystal layer being made from a material which has (i) an optical isotropy while no voltage is applied to the liquid crystal layer and (ii) a refractive index that changes in an electric field direction in response to an applied voltage.

This makes it possible to carry out liquid crystal display while having a backlight function. It is therefore possible not only to considerably reduce the number of components but also to reduce the thickness of the image display apparatus.

### BRIEF DESCRIPTION OF DRAWINGS

FIG. 1

FIG. 1 is a cross-sectional view showing a configuration of a backlight device in accordance with an embodiment of the present invention.

FIG. 2 is a view showing a configuration of an electrode provided in the backlight device of FIG. 1. (a) of FIG. 2 shows a state where a voltage is applied. (b) of FIG. 2 shows a state where no voltage is applied.

FIG. 3

FIG. 3 is a view showing a modified example of the configuration of the electrode provided in the backlight device of FIG. 1.

FIG. 4

FIG. 4 is a view schematically showing a configuration of a liquid crystal display apparatus of the present embodiment.

FIG. 5(a)

FIG. 5(a) is a cross-sectional view showing a configuration of a backlight device in accordance with another embodiment of the present invention. FIG. 5(b)

FIG. 5(b) is a cross-sectional view showing a configuration of a backlight device in accordance with another embodiment of the present invention.

FIG. 5(c)

FIG. 5(c) is a cross-sectional view showing a configuration of a backlight device in accordance with another embodiment of the present invention.

FIG. 6

FIG. 6 is a cross-sectional view showing a configuration of a backlight device in accordance with yet another embodiment of the present invention.

FIG. 7

FIG. 7 is a plain view of electrodes of the backlight device of FIG. 6.

FIG. 8

FIG. 8 is a cross-sectional view showing a configuration of a backlight device in accordance with yet another embodiment of the present invention.

FIG. 9

FIG. 9 is a cross-sectional view showing a configuration of a backlight device in accordance with yet another embodiment of the present invention.

FIG. 10(a)

FIG. 10(a) is a cross-sectional view showing a configuration of a backlight device in accordance with yet another embodiment of the present invention.

FIG. 10(b)

FIG. 10(b) is a cross-sectional view showing a configuration of a backlight device in accordance with yet another embodiment of the present invention.

FIG. 10(c)

FIG. 10(c) is a cross-sectional view showing a configuration of a backlight device in accordance with yet another embodiment of the present invention.

FIG. 11

FIG. 11 is a view showing a conventional configuration.

FIG. 12 is a view showing a conventional configuration.

FIG. 13

FIG. 13 is a view showing a conventional configuration.

FIG. 14

FIG. 14 is a view showing a conventional configuration.

### DESCRIPTION OF EMBODIMENTS

### Embodiment 1

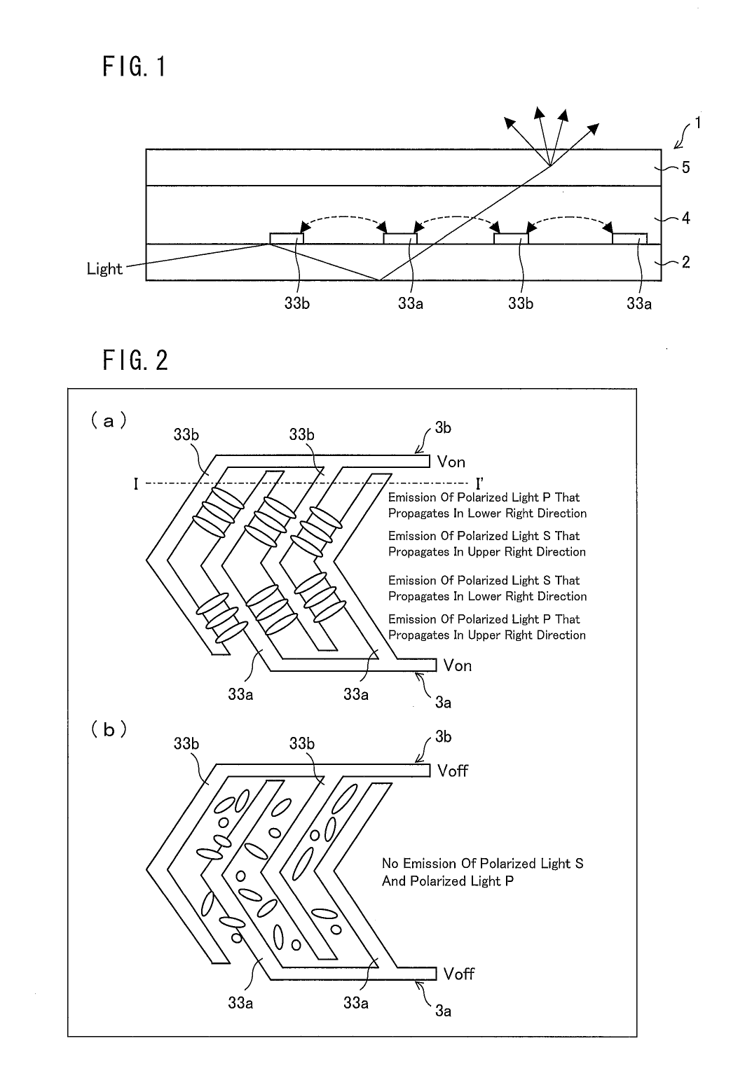

The following description will discuss an embodiment of the present invention with reference to FIGS. 1 through 4. A backlight device of the present embodiment can be used as external illumination means that is to be provided in a television receiver or a liquid crystal display apparatus having a function of displaying an image (video).

Described first is a configuration and an operation of the backlight device having a characteristic configuration of the present invention. Described second are (i) a configuration of an image display apparatus including the backlight device and (ii) another example of the image display apparatus.

[Backlight Device]

(1) Configuration of Backlight Device

FIG. 1 is a cross-sectional view showing a configuration of a backlight device of the present embodiment. As shown in FIG. 1, a backlight device 1 includes a light guide plate that includes a substrate 2, a plurality of electrodes 33a and a plurality of electrodes 33b, a liquid crystal layer 4, and a scattering layer 5.

(Substrate)

The substrate 2 can be made from, for example, polystyrene having a refractive index of 1.61. The substrate 2 has a surface on which the plurality of electrodes 33a and the plurality of electrodes 33b can be provided. The liquid crystal layer 4 is provided on a side of the substrate 2, on which side the plurality of electrodes 33a and the plurality of electrodes 33b are provided. The substrate 2 is configured so as to guide, into the substrate 2, natural light or light emitted from a light source via its side part.

(Electrode)

The plurality of electrodes 33a and the plurality of electrodes 33b, each made from an electrode material such as ITO, are provided on the surface of the substrate 2. FIG. 1 shows, in section, the plurality of electrodes 33a and the plurality of electrodes 33b when they are taken along I-I′ line of the (a) of FIG. 2.

The following description will discuss how the plurality of electrodes 33a and the plurality of electrodes 33b are configured, with reference to (a) of FIG. 2 and (b) of FIG. 2. (a) of FIG. 2 and (b) of FIG. 2 each are a plan view of the plurality of electrodes 33a and the plurality of electrodes 33b, and the plan views are obtained when the substrate 2 is viewed from the surface side of the substrate 2, on which surface the plurality of electrodes 33a and the plurality of electrodes 33b are provided. Note that (a) of FIG. 2 shows a state where a voltage is applied to comb-teeth electrodes 3a and 3b. (b) of FIG. 2 shows a state where no voltage is applied to the comb-teeth electrodes 3a and 3b.

The plurality of electrodes 33a and the plurality of electrodes 33b correspond to a plurality of comb-teeth parts 33a and a plurality of comb-teeth parts 33b of comb electrodes 3a and 3b, respectively (see (a) of FIG. 2 and (b) of FIG. 2). The plurality of electrodes 33a and the plurality of electrodes 33b are arranged so that (i) the plurality of comb-teeth parts 33a (the electrodes 33a) of the comb electrode 3a mesh with the plurality of comb-teeth parts 33b (the electrodes 33b) of the comb electrode 3b or (ii) the plurality of comb-teeth parts 33a and the plurality of comb-teeth parts 33b have a nested structure. That is, the plurality of electrodes 33a and the plurality of electrodes 33b are arranged so that each of the plurality of comb-teeth parts 33b (the electrodes 33b) of the comb electrode 3b is located between corresponding adjacent ones of the plurality of comb-teeth parts 33a (the electrodes 33a) of the comb electrode 3a.

A voltage is applied, by a driving circuit (not shown), to the comb electrodes 3a and 3b (the plurality of electrodes 33a and the plurality of electrodes 33b). This causes at least two electric fields, having their respective different directions parallel to the surface of the substrate 2, to be generated along the surface of the substrate 2 in the liquid crystal layer 4. That is, the plurality of electrodes 33a and the plurality of electrodes 33b are arranged so that a phase difference(s) is generated, between the at least two electric fields, in a direction parallel to the surface of the substrate 2, in response to a voltage applied to the comb electrodes 3a and 3b. (a) of FIG. 2 shows a state where liquid crystal molecules are aligned in response to two generated electric fields having their respective directions. Note that, in FIG. 1, directions of the generated electric fields are indicated by dashed arrows. Also note that the direction parallel to the surface of the substrate 2 includes (i) a first direction completely parallel to the surface of the substrate 2 and (ii) a second direction substantially parallel to the surface of the substrate 2, which second direction can bring about an effect equal to that brought about by the first direction.

In this case, there is a region whose effective refractive indexes with respect to polarized light p and polarized light s become large. For example, refractive indexes of an upper right region of (a) of FIG. 2 with respect to (i) polarized light p that propagates in a lower right direction and (ii) polarized light s that propagates in an upper right direction become maximum. This causes the polarized light p and the polarized light s to be emitted from the backlight device 1. Further, refractive indexes of a lower right region of (a) of FIG. 2 with respect to (i) polarized light s that propagates in the lower right direction and (ii) polarized light p that propagates in the upper right direction become maximum. This causes the polarized light s and the polarized light p to be emitted from the backlight device 1.

In contrast, while no voltage is applied to the plurality of electrodes 33a and the plurality of electrodes 33b, the liquid crystal molecules are not aligned in two directions (see (b) of FIG. 2) or are isotropic. Therefore, neither polarized light s nor polarized light p is emitted while no voltage is applied to the plurality of electrodes 33a and the plurality of electrodes 33b.

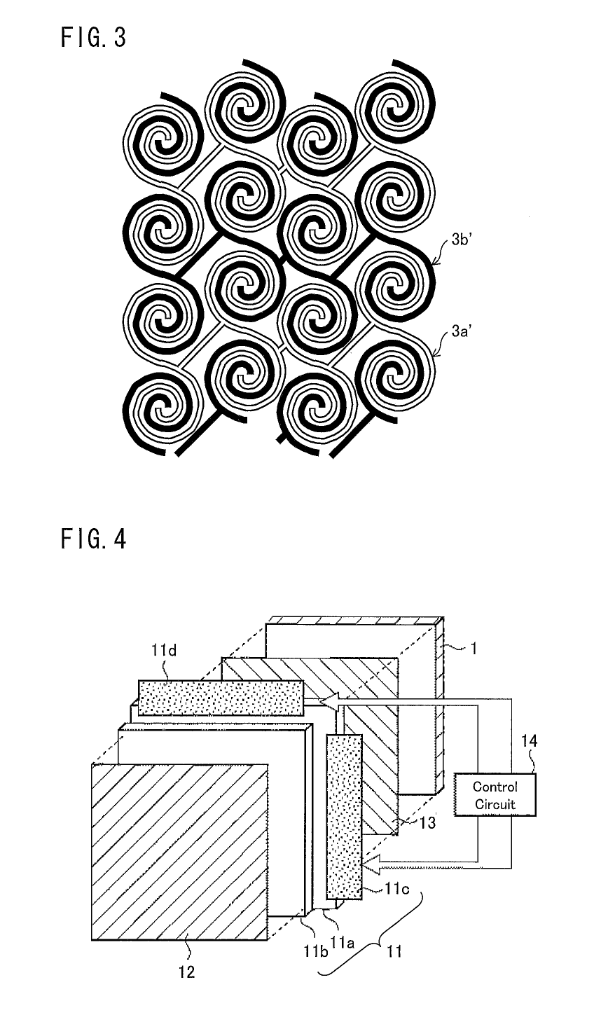

Note that the configuration of the plurality of electrodes 33a and the plurality of electrodes 33b are not limited to the configuration of (a) of FIG. 2 and (b) of FIG. 2, provided that the plurality of electrodes 33a and the plurality of electrodes 33b are configured to generate, in response to an applied voltage, the electric fields (i) in the liquid crystal layer 4 in the direction parallel to the surface of the substrate 2 and (ii) in the at least two directions different from each other. The plurality of electrodes 33a and the plurality of electrodes 33b can be, for example, omnidirectional electrodes 3a′ and omnidirectional electrodes 3b′, that is, electrodes 3a′ and electrodes 3b′ each of which is in a shape of a circle or a double volute (see FIG. 3). In this case, the circle part or the double volute part functions identically with the plurality of electrodes (comb-teeth parts) 33a and the plurality of electrodes 33b. The electrodes 3a′ and the electrodes 3b′ generate electric fields in various directions in a liquid crystal layer. Therefore, birefringence of liquid crystal molecules is also generated in various directions. It is therefore possible to control propagation light of polarized light s and polarized light p, which propagation light propagates in different directions.

(Liquid Crystal Layer)

The liquid crystal layer 4 includes liquid crystal molecules (i) that show an optical isotropy while no voltage is applied and (ii) whose refractive index changes in an electric field direction in response to an applied voltage. Specifically, the liquid crystal layer 4 is operable in Blue Phase Mode. In the Blue Phase Mode, the liquid crystal layer 4 has a refractive index of approximately 1.55 while no voltage is applied. The liquid crystal layer 4 is operable in Blue Phase Mode in a case where it employs Cholesteric liquid crystal having an extraordinary index of approximately 1.62. In this case, it is possible to change a refractive index of the liquid crystal layer 4 into 1.6 that is substantially equal to that of the substrate 2 made from polystyrene, while a voltage is being applied to the liquid crystal layer 4.

(Scattering Layer)

The scattering layer 5 is provided on a light-emitting surface side of the liquid crystal layer 4. The scattering layer 5 is configured to (i) receive light from the liquid crystal layer 4 and (ii) emit, as scattered light, the light outside the backlight device 1.

A material for the scattering layer 5 is not limited to a specific material, provided that the material has the above function. The scattering layer 5 can be, for example, a layer in which silica particles are dispersed. In this case, light that enters such a layer in which silica particles are dispersed is refracted and scattered in various directions by the silica particles.

According to the backlight device 1 of the present embodiment, neither polarized light p nor polarized light s is emitted from the backlight device 1 but merely propagates in the substrate 2. This is because the backlight device 1 of the present embodiment has a uniform layer having an optical isotropy while no voltage is applied. In contrast, since the liquid crystal layer has regions whose respective refractive indexes are increased in respective two directions along the surface of the substrate 2 in response to an applied voltage, the polarized light p is emitted from a region in one of the two directions and the polarized light s is emitted from a region in the other of the two directions. It is therefore possible to control emissions of both the polarized light p and the polarized light s.

The above-configured backlight device 1 can emit light merely from some desired regions. This can be attained by causing (i) light to be emitted from regions where a voltage(s) is applied to the plurality of electrodes 33a (comb-teeth parts) and the plurality of electrodes 33b (comb-teeth parts) and (ii) no light to be emitted from regions where no voltage is applied. This can be understood by envisioning, for example, a state in which a plurality of electrode configurations of (a) of FIG. 2 and (b) of FIG. 2 are provided on the substrate 2. Light is emitted merely from regions where a voltage is applied to the electrodes in the electrode configurations provided on the substrate 2. That is, it is possible to provide a backlight device for emitting light merely from some specific (desired) regions, by causing a control device (not shown) to control the electrodes in the electrode configurations to which a voltage(s) is to be applied.

The following description will discuss an example configuration of an image display apparatus in which the above-configured backlight device is employed as external illumination means of the image display apparatus.

[Image Display Apparatus]

FIG. 4 schematically shows a configuration of a liquid crystal display apparatus of the present embodiment. As shown in FIG. 4, a liquid crystal display apparatus 10 includes the above-described backlight device 1, a liquid crystal panel 11, a front side polarizing plate 12 provided on a front side of the liquid crystal panel 11, a backside polarizing plate 13 provided on a backside of the liquid crystal panel 11, and a control circuit 14.

The liquid crystal panel 11 includes (i) a TFT substrate 11a, (ii) a counter substrate 11b including a color filter and a common electrode, and (iii) liquid crystal having, for example, a negative dielectric anisotropy, which liquid crystal is sealed between the TFT substrate 11a and the counter substrate 11b. The TFT substrate 11a includes a plurality of gate bus lines and a plurality of drain bus lines which intersect with each other via an electrically insulating film, and TFTs and pixel electrodes provided for respective pixels. Connected to the TFT substrate 11a are (a) a gate bus line driving circuit 11c including a driver IC for driving the plurality of gate bus lines and (b) a drain bus line driving circuit 11d including a driver IC for driving the plurality of drain bus lines. The gate bus line driving circuit 11c supplies a scanning signal to a corresponding gate bus line, in response to a predetermined signal supplied from the control circuit 14. The drain bus line driving circuit 11d supplies a data signal to a corresponding drain bus line, in response to a predetermined signal supplied from the control circuit 14.

The backside polarizing plate 13 is provided on a surface of the TFT substrate 11a which surface is opposite to a surface on which TFT devices are provided.

The front side polarizing plate 12 is provided on a surface of the counter substrate 11b which surface is opposite to a surface on which the common electrode is provided. The front side polarizing plate 12 and the backside polarizing plate 13 are provided so as to have a crossed Nicols arrangement.

The backlight device 1 is provided on a surface of the backside polarizing plate 13 which surface is opposite to a surface on which the TFT substrate 11a is provided. The backlight device 1 serves as external illumination means for visualizing an electronic latent image formed on the liquid crystal display panel 11.

Since the image display apparatus is thus configured, the backlight device functions as area control type external illumination means. It is therefore possible to limit an area for image display.

The backlight device can guide both polarized light p and polarized light s. It is therefore possible to secure a desired light quantity for image display without increasing an output of a light source provided in the backlight device, unlike a conventional case where merely one of polarized light p and polarized light s is employed. Hence, it is possible to reduce power consumption, as compared with the conventional configuration.

[Another Example of Image Display Apparatus]

The image display apparatus described above with reference to FIG. 4 employs the backlight device of FIG. 1 as external illumination means of the liquid crystal panel 11. A backlight device itself can be an image display apparatus which functions as display means and illumination means, in a case where such an image display apparatus is configured such that (i) a switching device such as a TFT is provided in each of a plurality of electrodes 33a and a plurality of electrodes 33b or (ii) a voltage to be applied to a region is controlled by a duty driving.

In a case where the backlight device of FIG. 1 itself is such an image display apparatus, it is possible to (i) reduce the number of components and (ii) provide a thinner image display apparatus, as compared with the image display apparatus of FIG. 4.

### Embodiment 2

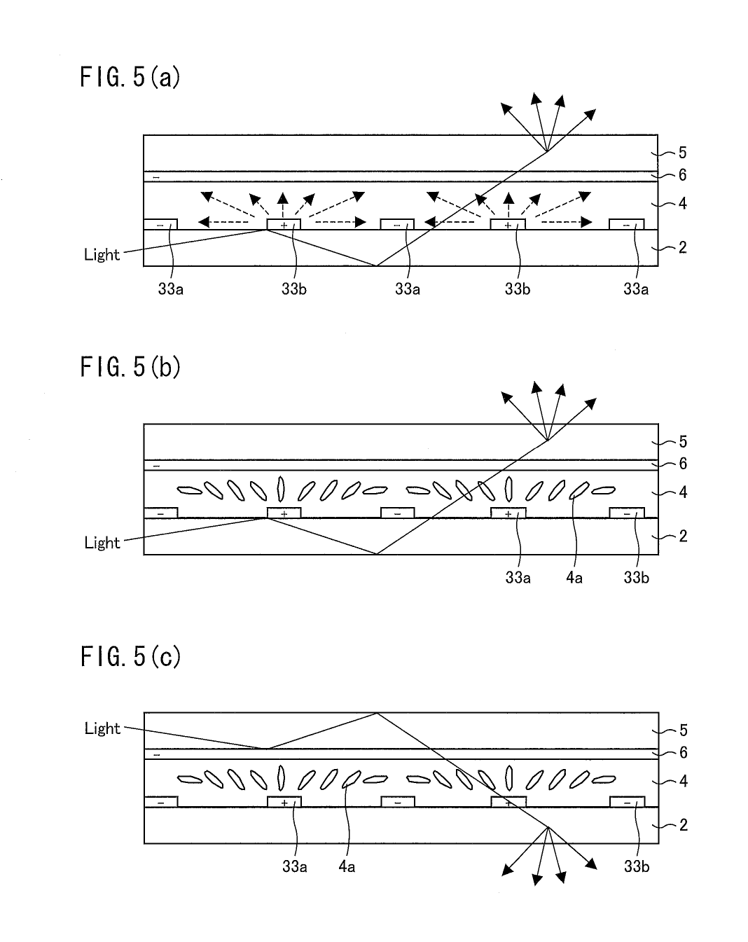

The following description will discuss Embodiment 2 of the present invention with reference to FIGS. 5(a) through 5(c). Note that Embodiment 2 describes differences from Embodiment 1. For convenience, identical reference numerals are given to members having functions identical to those of the members in Embodiment 1, and their descriptions are omitted here.

Each of FIGS. 5(a) and 5(b) is a cross-sectional view showing a configuration of a backlight device of Embodiment 2. Embodiment 2 is different from Embodiment 1 in that a solid electrode 6 is provided between a liquid crystal layer 4 and a scattering layer 5.

Specifically, the backlight device of Embodiment 2 includes, in addition to a plurality of electrodes 33a and a plurality of electrodes 33b provided on a substrate 2, the solid electrode 6 provided between the liquid crystal layer 4 and the scattering layer 5 so as to completely coat the surface of the scattering layer 5 (see FIG. 5(a)).

In a case where voltages (positive voltages and negative voltages) are applied to the plurality of electrodes 33a and the plurality of electrodes 33b and the solid electrode 6 as shown in FIG. 5(a), it is possible to generate electric fields in the liquid crystal layer 4 (i) in a direction parallel to a surface of the substrate 2 (hereinafter referred to also as a lateral direction), (ii) in a direction perpendicular to the surface of the substrate 2 (hereinafter referred to also as a longitudinal direction), and (iii) in oblique directions (see dashed arrows of FIG. 5(a)).

The electric fields generated in the directions cause liquid crystal molecules 4a of the liquid crystal layer 4 to orient as shown in FIG. 5(b).

The above-configured backlight device of the Embodiment 2 can generate electric fields in various directions on the surface of the substrate 2, as with Embodiment 1. In this case, it is possible to surely increase an effective refractive index of polarized light p that is oscillating in the direction perpendicular to the substrate 2. This causes light of the polarized light p and light of the polarized light s to be emitted from the scattering layer 5.

Note that it is possible to provide (i) a solid ITO substrate on a substrate side to which light is guided and (ii) a comb electrode on a side opposite to the substrate side via the liquid crystal layer. This is shown in FIG. 5(c). As shown in FIG. 5(c), guided light enters the liquid crystal layer 4 in which the liquid crystal molecules 4a are oriented along the electric fields generated in the lateral direction, in the longitudinal direction, and in the oblique directions. Subsequently, the guided light is emitted outside of the substrate 2 by a scattering reflection structure provided outside of the substrate 2. This also causes light of the polarized light p and light of the polarized light s to be emitted from the scattering layer 5.

### Embodiment 3

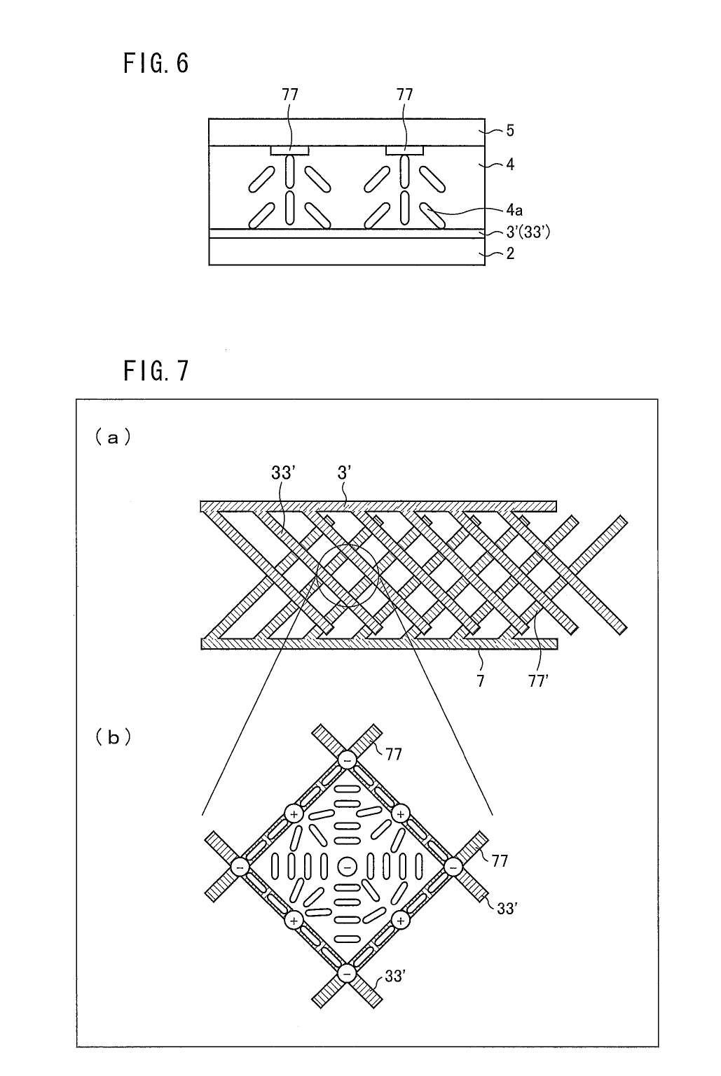

The following description will discuss Embodiment 3 of the present invention with reference to FIGS. 6, and (a) of FIG. 7 and (b) of FIG. 7. Note that Embodiment 3 describes differences from Embodiment 1. For convenience, identical reference numerals are given to members having functions identical to those of the members in Embodiment 1, and their descriptions are omitted here.

FIG. 6 is a partial cross-sectional view showing a configuration of a backlight device of Embodiment 3. Embodiment 3 is different from Embodiment 1 in that the backlight device of Embodiment 3 includes (i) a plurality of comb-teeth parts (electrodes) 33′ provided between a substrate 2 and a liquid crystal layer 4 and (ii) a comb electrode 7 including a plurality of comb-teeth parts 77 provided on a scattering layer 5 so as to face the liquid crystal layer 4. Embodiment 3 is also different from Embodiment 1 in that the plurality of comb-teeth parts (electrodes) 33′ and the plurality of comb-teeth parts 77 are provided so as to intersect with each other (see (a) of FIG. 7) in a case where the plurality of comb-teeth parts (electrodes) 33′ and the plurality of comb-teeth parts 77 are perpendicularly viewed from a substrate 2 side.

Each of the plurality of comb-teeth parts (electrodes) 33′ and the plurality of comb-teeth parts 77 can have a width of 10 μm. The plurality of comb-teeth parts (electrodes) 33′ and the plurality of comb-teeth parts 77 each can be provided at intervals of 50 μm. Note that a comb electrode 3′ (the plurality of comb-teeth parts 33′) and the comb electrode 7 (the plurality of comb-teeth parts 77) can be made from a conventionally known transparent electrode material such as ITO.

According to the configuration of Embodiment 3, the comb electrode 3′ (the plurality of comb-teeth parts 33′) and the comb electrode 7 (the plurality of comb-teeth parts 77) receive respective reverse voltages. This configuration causes liquid crystal molecules 4a of the liquid crystal layer 4 to be oriented in a longitudinal direction and in oblique directions along electric fields generated in response to an applied voltage (see FIG. 6). (b) of FIG. 7 shows how the liquid crystal molecules 4a orient when they are viewed from above. As shown in (b) of FIG. 7, the liquid crystal molecules 4a are oriented in various directions, i.e., in a longitudinal direction, in a lateral direction, and in oblique directions.

That is, it is possible to control whether to emit not only polarized light p and polarized light s but also polarized light propagated in all directions.

Even in a case where there occurs a relatively two-dimensional displacement between the substrate 2 and the scattering layer 5, the plurality of comb-teeth parts 33′ and the plurality of comb-teeth parts 77 still intersect with each other. The above-described relationship is therefore kept. Hence, it can be said that the configuration of Embodiment 3 is easy to produce.

### Embodiment 4

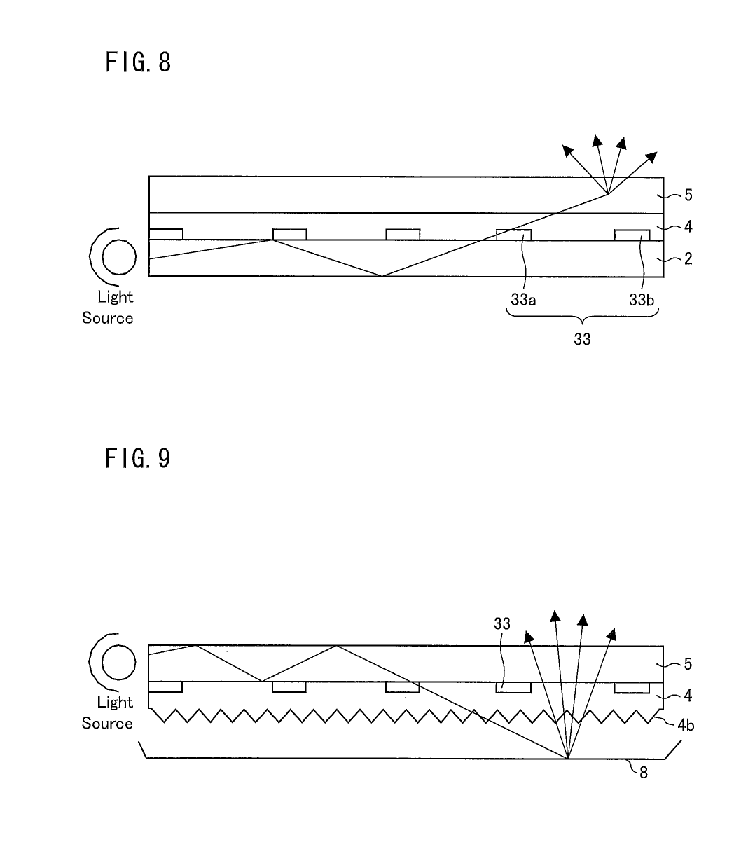

The following description will discuss Embodiment 4 of the present invention with reference to FIG. 8. Note that Embodiment 4 describes differences from Embodiment 1. For convenience, identical reference numerals are given to members having functions identical to those of the members in Embodiment 1, and their descriptions are omitted here.

FIG. 8 is a cross-sectional view showing a configuration of a backlight device of Embodiment 4. Embodiment 4 is different from Embodiment 1 in that (i) a substrate 2 of Embodiment 4 is a solid ready-made member and (ii) other layers of Embodiment 4 are optical layers which have been subjected to an ultraviolet curing process.

That is, the backlight device of Embodiment 4 employs a plastic ready-made substrate as a substrate 2, on a surface of which a comb electrode 33 made from an electrode material (for example, ITO) is provided.

A mixture of an ultraviolet curing resin and liquid crystal molecules is applied to the surface on which the comb electrode 3 is provided, and then the surface is irradiated with ultraviolet rays to be cured. A liquid crystal layer 4 is thus produced. Blue Phase Mode or a polymer dispersed liquid crystal phase can be employed as a liquid crystal display mode. Basically, any phase can be employed, provided that it has (i) an optical isotropy while no voltage is applied and (ii) a refractive index that changes in an electric field direction in response to an applied voltage.

After the liquid crystal layer 4 is formed, a scattering layer 5, in which a polymer and a scattering material such as silica particles are mixed, is formed. Specifically, the scattering layer 5 is formed by applying an ultraviolet curing resin in which silica particles are mixed to the liquid crystal layer 4, and then irradiating the ultraviolet curing resin with ultraviolet rays.

According to the backlight device of Embodiment 4 also, light that has entered from a side part of the substrate 2 is guided in the substrate 2 but is not emitted from the scattering layer 5 while no voltage is applied. In contrast, while a voltage is being applied, light that has entered a layer such as the liquid crystal layer 4 reaches, as it is, the scattering layer 5, and is then scattered and emitted outside from the scattering layer 5.

It is thus possible to control whether to partially emit light by use of a very simple configuration.

### Embodiment 5

The following description will discuss Embodiment 5 of the present invention with reference to FIG. 9. Note that Embodiment 5 describes differences from Embodiment 1. For convenience, identical reference numerals are given to members having functions identical to those of the members in Embodiment 1, and their descriptions are omitted here.

FIG. 9 is a cross-sectional view showing a configuration of a backlight device of Embodiment 5. Embodiment 5 is different from Embodiment 1 in that (i) a liquid crystal layer 4 of Embodiment 5 has a light-emitting surface on which a convexoconcave shape 4b is formed instead of providing the scattering layer 5 of Embodiment 1 and (ii) a diffusion reflection plate 8 is provided so as to face the convexoconcave shape 4.

Specifically, the backlight device of Embodiment 5 is devised to bring about, instead of providing a scattering layer, an effect identical to that brought about in a case where a scattering layer is provided. Specifically, the liquid crystal layer 4 operable in, for example, Blue Phase Mode is provided on a lower surface of a substrate 2, and a surface of the liquid crystal layer 4 has been subjected to embossing so as to have the convexoconcave shape 4b. Note that, instead of the convexoconcave shape 4b obtained by the embossing, it is possible to obtain a similar effect by causing the surface of the liquid crystal layer 4 to be subjected to a surface treatment so that the surface has roughness. Light emitted from a light source enters the liquid crystal layer 4, which is in Blue Phase Mode, in response to an applied voltage. The light is then emitted from the convexoconcave shape 4b. This is because the convexoconcave shape 4b causes a total reflection condition not to be met. The light emitted from the convexoconcave shape 4b (i) is reflected from the diffusion reflection plate 8 and (ii) enters and retransmits the liquid crystal layer 4 and the substrate 2, so that the light thus retransmitted is emitted toward an observer or upward. Note that a reflective plate merely having a reflection function can be provided instead of the diffusion reflection plate 8.

According to the configuration of Embodiment 5, it is possible to control whether to partially emit light, as with Embodiment 1.

Note that the light source and the substrate 2 of Embodiment 5 are provided closer to the observer, unlike Embodiment 1. Therefore, the configuration of Embodiment 5 can be employed, in a case where there is no space for providing a light source on a side opposite to an observer side but there is a space for providing the light source on the observer side.

### Embodiment 6

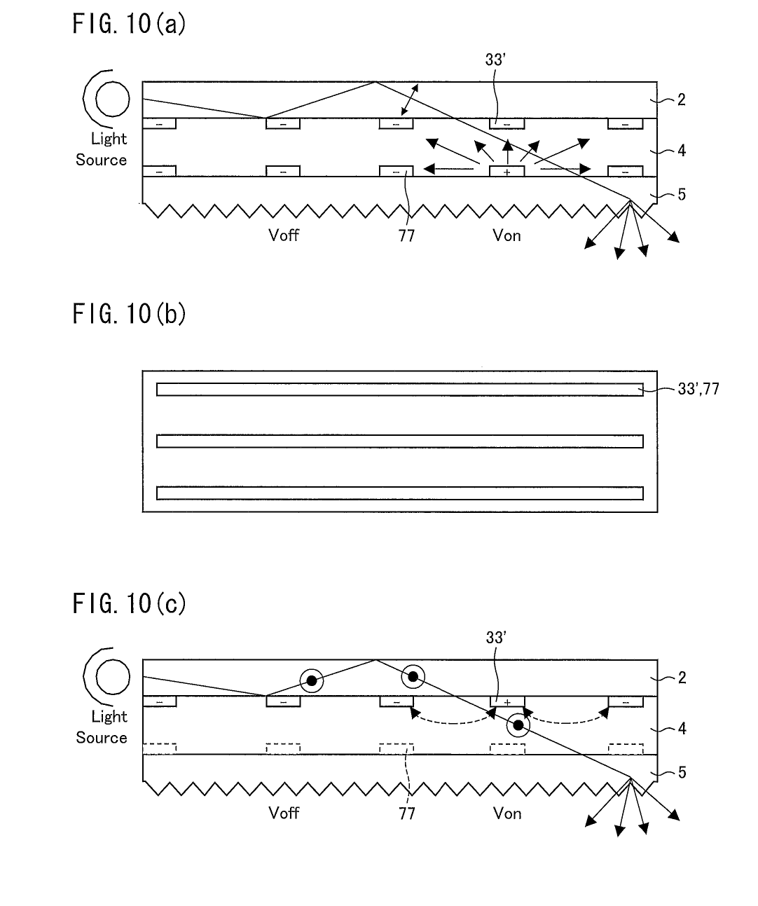

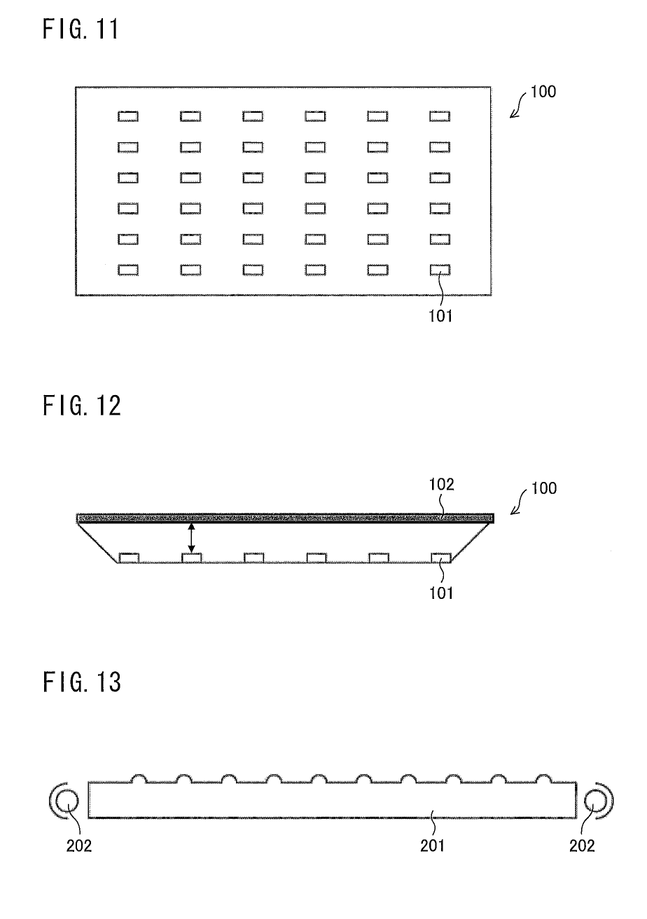

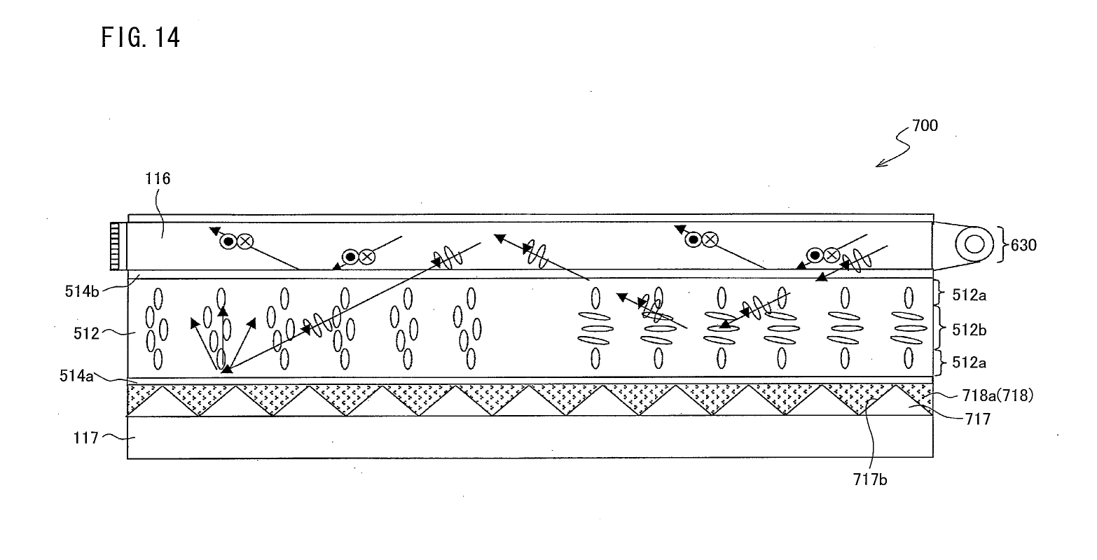

The following description will discuss Embodiment 6 of the present invention with reference to FIG. 10(a) through FIG. 10(c). Note that Embodiment 6 describes differences from Embodiment 1. For convenience, identical reference numerals are given to members having functions identical to those of the members in Embodiment 1, and their descriptions are omitted here.

FIG. 10(a) is a cross-sectional view showing a configuration of a backlight device of Embodiment 6. Embodiment 6 is different from Embodiment 1 in that (i) a comb electrode 3′ including a plurality of comb-teeth parts 33′ is provided on a lower surface of a substrate 2 and (ii) a comb electrode 7 including a plurality of comb-teeth parts 77 is provided on an upper surface of a scattering layer 5. It follows that the plurality of comb-teeth parts 33′ are configured to face the respective plurality of comb-teeth parts 77 in a direction perpendicular to the substrate 2. That is, the plurality of comb-teeth parts 33′ which are juxtaposed to each other are provided so as to overlap with the respective plurality of comb-teeth parts 77 which are juxtaposed to each other, when viewed from above (see FIG. 10(b)).

Such a configuration makes it possible to control the propagation of polarized light p in a case where an electric field substantially perpendicular to the substrate 2 is applied between the plurality of comb-teeth parts 33′ provided on the substrate 2 and the plurality of comb-teeth parts 77 provided on the scattering layer 5.

Meanwhile, whether to emit polarized light s is controlled as follows. Namely, a voltage is applied between the respective adjacent comb-teeth parts 33′ provided on the substrate 2 so as to generate an electric field in a lateral direction. It is therefore possible to generate a region where refractive index is increased in a direction parallel to an electric field direction of the polarized light s (see FIG. 10(c)). This allows the polarized light s not to be emitted. Note that, although the configuration of FIG. 10(a) can also control polarized light s, the configuration of FIG. 10(c) can improve an efficiency, as compared with that of FIG. 10(a).

According to the configuration of Embodiment 6, it is possible to control whether to partially emit light, as with Embodiment 1.

The present invention is not limited to the description of Embodiments 1 through 6, and can therefore be modified by a skilled person in the art within the scope of the claims. Namely, an embodiment derived from a proper combination of technical means disclosed in different embodiments is encompassed in the technical scope of the present invention.

(Summary of the Present Invention)

A backlight device of the present invention is a backlight device, including a light guide plate configured to emit light merely from a partial region of the light guide plate, the light guide plate including: a substrate having a side part configured to guide light into the substrate; a liquid crystal layer, provided on a side of a surface of the substrate, that is made from a material which has (i) an optical isotropy while no voltage is applied to the liquid crystal layer and (ii) a refractive index that changes in an electric field direction in response to an applied voltage; and a plurality of electrodes for causing electric fields to be generated in the liquid crystal layer, in response to an applied voltage, in at least two different directions each parallel to the surface of the substrate. Further, it is preferable that the light guide plate include a structure, provided such that the liquid crystal layer is located between the substrate and the structure, for scattering or reflecting incident light to emit the incident light.

According to configuration, the backlight device of the present invention can scatter, by use of the structure, light that passed through the liquid crystal layer.

It is preferable to further configure the backlight device of the present invention such that the liquid crystal layer have a surface having a convexoconcave shape, the surface being opposite to a surface facing the substrate.

According to the configuration, the convexoconcave shape can scatter light that passed through the liquid crystal layer. The configuration also makes it possible to reduce the number of components, as compared with a configuration in which the scattering plate is provided.

It is preferable that the backlight device of the present invention further include a diffusion reflection plate, facing the surface having the convexoconcave shape, for reflecting and diffusing incident light.

The backlight device of the present invention includes the diffusion reflection plate, facing the surface having the convexoconcave shape, for reflecting and diffusing incident light. This makes it possible to cause scattered light to efficiently reach an observer side.

It is preferable to further configure the backlight device of the present invention such that the plurality of electrodes are first and second comb electrodes each of which includes a plurality of comb-teeth parts, the plurality of comb-teeth parts of the first comb electrode and the plurality of comb-teeth parts of the second comb electrode meshing with each other or having a nested structure.

According to the configuration, the backlight device of the present invention can generate the electric fields in the liquid crystal layer, in response to an applied voltage, in the directions each parallel to the surface of the substrate, by use of the first and second comb electrodes each of which includes the plurality of comb-teeth parts, the plurality of comb-teeth parts of the first comb electrode and the plurality of comb-teeth parts of the second comb electrode meshing with each other.

It is preferable to further configure the backlight device of the present invention such that the structure be a plate member, and an electrode be provided between the plate member and the liquid crystal layer so as to completely coat the plate member.

According to the configuration, a solid electrode is provided so as to completely coat the surface of the plate member. This makes it possible to generate electric fields in the liquid crystal layer, in response to an applied voltage, not only in a lateral direction but also in a longitudinal direction (in a direction perpendicular to the substrate) and in oblique directions. That is, this makes it possible to generate the electric fields in the liquid crystal layer in various directions. It is therefore possible to surely increase an effective refractive index of polarized light p whose electric field is oscillating mainly in the direction perpendicular to the substrate. This causes light of the polarized light p and light of polarized light s to be emitted.

It is preferable to further configure the backlight device of the present invention such that the structure be a plate member, the plurality of electrodes be a plurality of comb-teeth parts of a first comb electrode, and the plate member have a surface facing the liquid crystal layer, on which surface a second comb electrode, including a plurality of comb-teeth parts provided so as to intersect with the plurality of comb-teeth parts of the first comb electrode, is provided.

According to the configuration, even in a case where there occurs a slight displacement between the substrate and the plate member when the substrate and the plate member are provided so as to face with each other, the comb-teeth parts of the substrate and the comb-teeth parts of the plate member still intersect with each other. It is therefore possible to generate the electric fields in the lateral direction, and in the oblique directions.

That is, according to the configuration, a scope of a tolerance of production is expanded, and therefore the backlight device of the present invention is easily produced.

It is preferable to further configure the backlight device of the present invention such that the structure be a plate member, the plurality of electrodes be a plurality of comb-teeth parts of a first comb electrode, and the plate member have a surface facing the liquid crystal layer, on which surface a second comb electrode, including a plurality of comb-teeth parts provided so as to be parallel to the plurality of comb-teeth parts of the first comb electrode, is provided.

According to the configuration, it is possible to generate, between the electrode provided on the substrate and the electrode provided on the plate member, an electric field substantially perpendicular to the substrate. Further, according to the configuration, the substrate and the plate member have respective regions on which no electrode is provided. This makes it possible to generate the electric field substantially perpendicular to the substrate. It is therefore possible to control the propagation of polarized light p. Accordingly, the configuration is effective in whether to propagate the polarized light p.

In a case where a voltage is applied merely to the electrode provided on the substrate, an electric field is generated in a direction parallel to the substrate. It is therefore possible to generate a region where refractive index is increased in a direction parallel to an electric field direction of polarized light s. This allows the polarized light s not to be emitted.

That is, according to the configuration, it is also possible to control whether to emit the polarized light p and/or the polarized light s.

The backlight device of the present invention can employ, as the structure, a plate member in which silica particles are dispersed.

It is preferable to configure the backlight device of the present invention such that the structure be a plate member having a surface which has a convexoconcave shape, the surface being opposite to a surface facing the substrate.

This makes it possible to emit, as scattered light, light to be emitted.

The backlight device of the present invention can include a light source provided such that the light enters the side part of the substrate.

The backlight device of the present invention can be configured such that the plurality of electrodes be provided on the side of the surface of the substrate.

An image display apparatus of the present invention is an image display apparatus, including display means, said display means including: a substrate having a side part configured to guide light into the substrate; and a liquid crystal layer provided on the substrate, said display means further including: a plurality of electrodes for causing electric fields to be generated in the liquid crystal layer, in response to an applied voltage, in at least two different directions each parallel to a surface of the substrate, the liquid crystal layer being made from a material which has (i) an optical isotropy while no voltage is applied to the liquid crystal layer and (ii) a refractive index that changes in an electric field direction in response to an applied voltage. Further, it is preferable that the display means include a structure, provided such that the liquid crystal layer is located between the substrate and the structure, for scattering or reflecting incident light to emit the incident light.

It is preferable to further configure the image display apparatus of the present invention such that the liquid crystal layer have a surface having a convexoconcave shape, the surface being opposite to a surface facing the substrate.

It is preferable that the image display apparatus of the present invention further include a diffusion reflection plate, facing the surface having the convexoconcave shape, for reflecting and diffusing incident light.

It is preferable to further configure the image display apparatus of the present invention such that the plurality of electrodes be first and second comb electrodes each of which includes a plurality of comb-teeth parts, the plurality of comb-teeth parts of the first comb electrode and the plurality of comb-teeth parts of the second comb electrode meshing with each other or having a nested structure.

It is preferable to further configure the image display apparatus of the present invention such that the structure be a plate member, and an electrode be provided between the plate member and the liquid crystal layer so as to completely coat the plate member.

It is preferable to further configure the image display apparatus of the present invention such that the structure be a plate member, the plurality of electrodes be a plurality of comb-teeth parts of a first comb electrode, and the plate member have a surface facing the liquid crystal layer, on which surface a second comb electrode, including a plurality of comb-teeth parts provided so as to intersect with the plurality of comb-teeth parts of the first comb electrode, is provided.

It is preferable to further configure the image display apparatus of the present invention such that the structure be a plate member, the plurality of electrodes be a plurality of comb-teeth parts of a first comb electrode, and the plate member have a surface facing the liquid crystal layer, on which surface a second comb electrode, including a plurality of comb-teeth parts provided so as to be parallel to the plurality of comb-teeth parts of the first comb electrode, is provided.

It is preferable to further configure the image display apparatus of the present invention such that the structure be a plate member in which silica particles are dispersed.

It is preferable to further configure the image display apparatus of the present invention such that the structure have a surface having a convexoconcave shape, the surface being opposite to a surface facing the substrate.

It is preferable that the image display apparatus of the present invention further include a light source provided such that the light enters the side part of the substrate.

It is preferable to further configure the image display apparatus of the present invention such that the plurality of electrodes be provided on the side of the surface of the substrate.

It is preferable to further configure the image display apparatus of the present invention such that said display means further include control means for carrying out a control in which a voltage is selectively applied to at least some of the plurality of electrodes.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is suitably applicable not only to a backlight device of a display apparatus but also to, for example, a display apparatus itself. Therefore, the present invention is excellent in industrial applicability.

### REFERENCE SIGNS LIST

1: backlight device
2: substrate (light guide plate)
3a: comb electrode
3a′: electrode
3b: comb electrode
3b40 : electrode
4: liquid crystal layer (light guide plate)
4a: liquid crystal molecules
4b: uneven shape
5: scattering layer (scattering plate)
6: solid electrode
7: comb electrode
8: diffusion reflection plate
10: liquid crystal display apparatus
11: liquid crystal panel
11a: TFT substrate
11b: counter substrate
11c: gate bus line driving circuit
11d: drain bus line driving circuit
12: front side polarizing plate
13: backside polarizing plate
14: control circuit
33a: comb-teeth part (a plurality of electrodes)
33b: comb-teeth part (a plurality of electrodes)
33′: comb-teeth part (a plurality of electrodes)
77: comb-teeth part

1. A backlight device, comprising a light guide plate configured to emit light merely from a partial region of the light guide plate,
the light guide plate including:
a substrate having a side part configured to guide light into the substrate;
a liquid crystal layer, provided on a side of a surface of the substrate, that is made from a material which has (i) an optical isotropy while no voltage is applied to the liquid crystal layer and (ii) a refractive index that changes in an electric field direction in response to an applied voltage; and
a plurality of electrodes for causing electric fields to be generated in the liquid crystal layer, in response to an applied voltage, in at least two different directions each parallel to the surface of the substrate.

2. The backlight device as set forth in claim 1, wherein:
the light guide plate includes a structure, provided such that the liquid crystal layer is located between the substrate and the structure, for scattering or reflecting incident light to emit the incident light.

3. The backlight device as set forth in claim 1, wherein:
the liquid crystal layer has a surface having a convexoconcave shape, the surface being opposite to a surface facing the substrate.

4. The backlight device as set forth in claim 3, comprising a diffusion reflection plate, facing the surface having the convexoconcave shape, for reflecting and diffusing incident light.

5. The backlight device as set forth in claim 1, wherein:
the plurality of electrodes are first and second comb electrodes each of which includes a plurality of comb-teeth parts, the plurality of comb-teeth parts of the first comb electrode and the plurality of comb-teeth parts of the second comb electrode meshing with each other or having a nested structure.

6. The backlight device as set forth in claim 2, wherein:
the structure is a plate member, and
an electrode is provided between the plate member and the liquid crystal layer so as to completely coat the plate member.

7. The backlight device as set forth in claim 2, wherein:
the structure is a plate member,
the plurality of electrodes are a plurality of comb-teeth parts of a first comb electrode, and
the plate member has a surface facing the liquid crystal layer, on which surface a second comb electrode, including a plurality of comb-teeth parts provided so as to intersect with the plurality of comb-teeth parts of the first comb electrode, is provided.

8. The backlight device as set forth in claim 2, wherein:
the structure is a plate member,
the plurality of electrodes are a plurality of comb-teeth parts of a first comb electrode, and
the plate member has a surface facing the liquid crystal layer, on which surface a second comb electrode, including a plurality of comb-teeth parts provided so as to be parallel to the plurality of comb-teeth parts of the first comb electrode, is provided.

9. The backlight device as set forth in claim 2, wherein:
the structure is a plate member in which silica particles are dispersed.

10. The backlight device as set forth in claim 2, wherein:
the structure is a plate member having a surface which has a convexoconcave shape, the surface being opposite to a surface facing the substrate.

11. The backlight device as set forth in claim 1, comprising a light source provided such that the light enters the side part of the substrate.

12. The backlight device as set forth in claim 1, wherein:
the plurality of electrodes are provided on the side of the surface of the substrate.

13. An image display apparatus, comprising:
a backlight device recited in claim 1; and
a display panel.

14. An image display apparatus, comprising display means,
said display means including: a substrate having a side part configured to guide light into the substrate; and a liquid crystal layer provided on the substrate,
said display means further including:
a plurality of electrodes for causing electric fields to be generated in the liquid crystal layer, in response to an applied voltage, in at least two different directions each parallel to a surface of the substrate,
the liquid crystal layer being made from a material which has (i) an optical isotropy while no voltage is applied to the liquid crystal layer and (ii) a refractive index that changes in an electric field direction in response to an applied voltage.

15. The image display apparatus as set forth in claim 14, wherein:
the display means includes a structure, provided such that the liquid crystal layer is located between the substrate and the structure, for scattering or reflecting incident light to emit the incident light.

16. The image display apparatus as set forth in claim 14, wherein:
the liquid crystal layer has a surface having a convexoconcave shape, the surface being opposite to a surface facing the substrate.

17. The image display apparatus as set forth in claim 16, comprising a diffusion reflection plate, facing the surface having the convexoconcave shape, for reflecting and diffusing incident light.

18. The image display apparatus as set forth in claim 14, wherein:
the plurality of electrodes are first and second comb electrodes each of which includes a plurality of comb-teeth parts, the plurality of comb-teeth parts of the first comb electrode and the plurality of comb-teeth parts of the second comb electrode meshing with each other or having a nested structure.

19. The image display apparatus as set forth in claim 15, wherein:
the structure is a plate member, and
an electrode is provided between the plate member and the liquid crystal layer so as to completely coat the plate member.

20. The image display apparatus as set forth in claim 15, wherein:
the structure is a plate member,
the plurality of electrodes are a plurality of comb-teeth parts of a first comb electrode, and
the plate member has a surface facing the liquid crystal layer, on which surface a second comb electrode, including a plurality of comb-teeth parts provided so as to intersect with the plurality of comb-teeth parts of the first comb electrode, is provided.

21. The image display apparatus as set forth in claim 15, wherein:
the structure is a plate member,
the plurality of electrodes are a plurality of comb-teeth parts of a first comb electrode, and
the plate member has a surface facing the liquid crystal layer, on which surface a second comb electrode, including a plurality of comb-teeth parts provided so as to be parallel to the plurality of comb-teeth parts of the first comb electrode, is provided.

22. The image display apparatus as set forth in claim 15, wherein:
the structure is a plate member in which silica particles are dispersed.

23. The image display apparatus as set forth in claim 15, wherein:
the structure has a surface having a convexoconcave shape, the surface being opposite to a surface facing the substrate.

24. The image display apparatus as set forth in claim 14, comprising a light source provided such that the light enters the side part of the substrate.

25. The image display apparatus as set forth in of claim 14, wherein:
the plurality of electrodes are provided on the side of the surface of the substrate.

26. The image display apparatus as set forth in claim 14, wherein:
said display means further includes control means for carrying out a control in which a voltage is selectively applied to at least some of the plurality of electrodes.
